(19) United States
(12) Patent Application Publication
(10) Pub. No.: US 2004/0024902 A1
(43) Pub. Date: Feb. 5, 2004

(54) Megaco protocol with user termination

(76) Inventor: Olli Mikkola, Klaukkala (FI)

Correspondence Address: PILLSBURY WINTHROP, LLP, P.O. BOX 10500, MCLEAN, VA, 22102, US

(21) Appl. No.: 10/173,557

(22) Filed: Jun. 18, 2002

(51) Int. Cl. G06F 15/16

(52) U.S. Cl. 709/238; 709/231

(57) ABSTRACT

Megaco is a device control protocol defining a general framework for physically decomposed media gateway, where the intelligence of the gateway is in a master node called the media gateway controller and the actual switching and media transfer is performed in one or more slave nodes called the media gateway(s). In order to enable to transfer user-related information from the media gateway controller to the media gateway a user termination for the user's user-related information is created in the media gateway, the user termination being non-call-specific and associated with the user; and the media streams to and from the user are directed via the user termination.

### FIELD OF THE INVENTION

The invention relates to a Megaco protocol used between a media gateway (MG) and an external controller, called a media gateway controller (MGC), and particularly to implementing voice telephony using IP (Internet Protocol) called VoIP (voice over IP) in situations, where terminals are connected to a service utilizing the VoIP via a low capacity IP packet data network.

### BACKGROUND OF THE INVENTION

Megaco (defined identically in IETF RFC3015 and ITU-T H.248) is a device control protocol assigning data stream resources between decomposed user and control planes in telecommunications/data systems. In other words, Megaco defines a general framework for a physically decomposed media gateway, where the intelligence of the gateway is in a master node called the media gateway controller (MGC) and the actual switching and media transfer are performed in one or more slave nodes called the media gateway(s) or multimedia gateway(s). Herein the term media gateway is used. Megaco is used between the media gateway and the MGC for resource reservations, connection settings, media transformation settings, signal/event indications and processing, quality of service (QoS) settings, sending statistics information and signaling control.

Megaco is used, for example, in situations a call is established between two terminals, one using VoIP connections and the other being connected to the Public Switch Telephone Network (PSTN). Megaco is used also when enhanced voice handling, such as three party calls or conference calls, is provided by VoIP. Megaco can also be used in situations where one user, i.e. one terminal, is a member of several different calls, i.e. there may be several media streams targeted at one user.

As long as the user is connected to the system utilizing the Megaco, the user is connected to a media gateway controlled by a media gateway controller. At least when a call is established or released, the media gateway and the media gateway controller exchange information. The media gateway controller may identify call events, the encounter of which requires instructions to be sent from the media gateway controller to the media gateway. There are situations, when similar kinds of instructions apply to all calls made to or by the user (and thus the terminal), i.e. similar kinds of instructions apply to similar kinds of events.

Such instructions may relate to selecting which one(s) of the media streams to forward to the terminal when there are several media streams targeted at the terminal, but the user (and thus the terminal) needs to receive only one or only some of the media streams at a time. Another example is a situation where inband information is added in the media gateway. However, since the intelligence is in the MGC, and thus the instructions are in the MGC, and there is no mechanism to transfer the user's common instructions from the media gateway controller to the media gateway, the media gateway informs the MGC about every event relating to a packet and/or its media stream to which such instructions may apply and the MGC commands the media gateway to act according to an instruction, if any. This requires continuous message exchange between the MGC and the media gateway, causing unnecessary load and delays.

### BRIEF DESCRIPTION OF THE INVENTION

An object of the present invention is thus to provide a method and an apparatus for implementing the method so as to solve the above problem. The objects of the invention are achieved by a method and an arrangement which are characterized by what is stated in the independent claims. The preferred embodiments of the invention are disclosed in the dependent claims.

The invention is based on the idea of creating in the media gateway a user termination associated with the user and not relating to any specific call and directing all media streams via the user termination. The user termination is created preferably during terminal logging to the system and maintained preferably as long as the terminal stays logged on the system. Since the user termination is non-call-specific, part of the intelligence in the media gateway controller can be transferred to the user termination and applied to all of the user's media streams. The transferred intelligence, i.e. the instructions may relate to downlink filtering and scanning, inserting additional information to the uplink media stream or generating downlink inband information in specific cases or any combination thereof.

An advantage of the method and arrangement of the invention is that it provides means to transfer some intelligence to the media gate way so that it can independently perform functions without requesting instructions from the MGC. Thus unnecessary load and delays are avoided and yet the media gateway is maintained rather simple and the main intelligence and control are maintained in the MGC.

### BRIEF DESCRIPTION OF THE DRAWINGS

In the following the invention will be described in greater detail by means of preferred embodiments with reference to the attached [accompanying] drawings, in which

FIG. 1 illustrates a connection model of the Megaco according to the invention;

FIGS. 2 and 3 illustrate the basic architecture of a PMRoC-system utilizing the Megaco;

FIG. 4 is a signaling diagram illustrating user registration to PMROC services;

FIG. 5 is a signaling diagram illustrating updating user information in PMROC services;

FIG. 6 is a flow chart illustrating media stream filtering;

FIG. 7 is a flow chart illustrating adding of inband information;

FIG. 8 is a flow chart illustrating adding of downlink information; and

FIG. 9 is a flow chart illustrating adding of uplink information.

### DETAILED DESCRIPTION OF THE INVENTION

FIG. 1 illustrates the connection model of the Megaco protocol according to the invention and the basic elements in an environment where Megaco may be used. As stated earlier, the Megaco defines a general framework for a physically decomposed media gateway MG, where the intelligence of the gateway is in a master node called the media gateway controller MGC and the actual switching and media transfer are performed in one or more slave nodes called the media gateway(s) MG. Megaco (thick line) is used between the media gateway MG and the media gateway controller MGC for resource reservations, connection settings, media transformation settings, signal/event indications and processing, quality of service (QoS) settings, sending statistics information and signaling control. Thus, Megaco is a set of those messages that are used to control the MG. The basic Megaco protocol supports several different circuit and packet bearer types, such as TDM (time-division multiplexing) and ATM (asynchronous transfer mode), for example. The Megaco protocol employs the underlying TCP, UDP and IP protocols which further employ the physical layer resources.

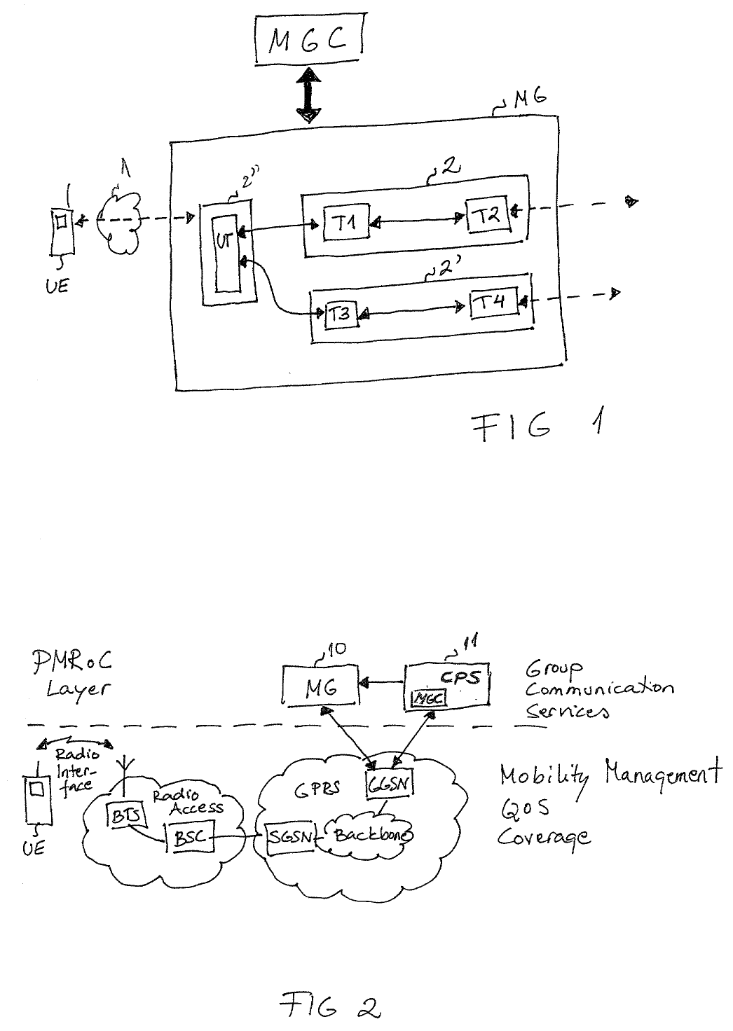

The media gateway controller MGC is the part of the gateway which commands the media gateway to connect and release the connections. In other words, the MGC performs the control plane functions and comprises the intelligence. The media gateway controller may, for example, be controlled by a so called soft switch or a SIP (Session Inititiation Protocol) proxy via which the actual signaling is routed, part of the soft switch or the SIP proxy, or it may be a network node via which the signaling is routed. Depending on how the MGC is implemented, it may be involved in signaling and may co-operate with other signaling protocols, such as SIP or it can receive control information with some protocol, such as Parlay API or SOAP (Simple Object Access Protocol, defined by the World Wide Web Consortium W3C). The media gateway controller according to the invention is described in more detail below with the connection model and with FIGS. 2 to 5. One media gateway controller controls one or more media gateways.

The media gateway MG converts media provided in one type of network to the format required in another type of network, e.g. between circuit switched networks and IP-based packet networks and is involved in traffic distribution of the IP layer, i.e. performs the user plane functions. The media gateway according to the invention is described in more detail below with the connection model and with FIGS. 2 to 9.

The user equipment UE, i.e. the terminal, is normally a phone, either a mobile phone or a fixed phone, but it can be any entity connected to a network 1. In this context, the user equipment UE generally refers to a combination of an actual terminal and a user of the terminal, i.e. with mobile phones, a combination of a mobile unit and a mobile subscriber identified in the system by e.g. a SIM (Subscriber Identity Module) card detachably coupled to the mobile unit or by requesting username and password, for example. Thus, herein the terminal and the user are interchangeable terms and it is assumed, for the sake of clarity that only one user uses the terminal at a time, and when the user changes, the previous user logs out of the system and the new user logs into the system.

Connection Model of the Megaco

For the sake of clarity the connection model of FIG. 1 describes the logical entities within the media gateway that can be controlled by the MGC and that relates only to one user UE.

The main abstractions are terminations T1, T2, T3, T4, and contexts 2, 2′, 2″. A termination is a logical entity that sources and/or sinks one or more media streams. The media stream parameters and bearer parameters are encapsulated within the termination. The termination can be considered as a call resource or a call leg. Examples of prior art terminations are PCM (pulse code modulation) timeslot for speech, RTP (real-time transport protocol) connection, ATM virtual connection. A context is an association between a collection of terminations that describes the topology (who hears/sees whom) and the media mixing and/or switching parameters if more than two terminations are involved in the same association. The context can be considered as a call or a session, and it may comprise several terminations. The maximum number of terminations in a context is a media-gateway-specific property. Media gateways that support only point-to-point connectivity may allow at most two terminations per one context. Media gateways that support multipoint conferences or group calls (term explained in more detail below) may allow three or more terminations per one context.

Priority values can be used by the MGC in order to provide the MG with information about certain precedence handling for a context, and an indicator for an emergency call is also provided to allow preference handling. The protocol provides commands for manipulating the logical entities of its connection model, contexts and terminations. Typical commands are add (adds a termination to a context), modify (modifies the properties of a termination), subtract (removes termination from a context) and notify (the media gateway notifies the MGC about certain events, such as off-hook, DTMF tone detection).

Megaco protocol provides packages with which properties not included in the base protocol can be defined so that the interoperability between the media gateway controller and the media gateway is achieved. Packages allow terminations to have optional properties, events, signals and statistics implemented by the media gateway. Such options are grouped in packages, and a termination realizes a set of such packages.

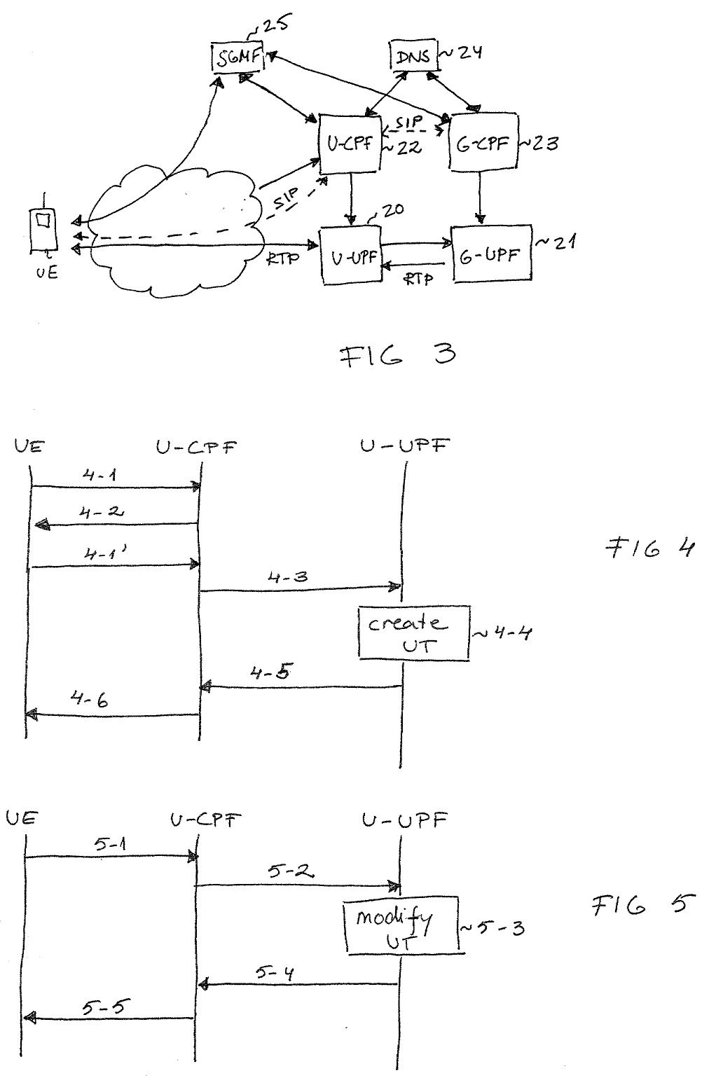

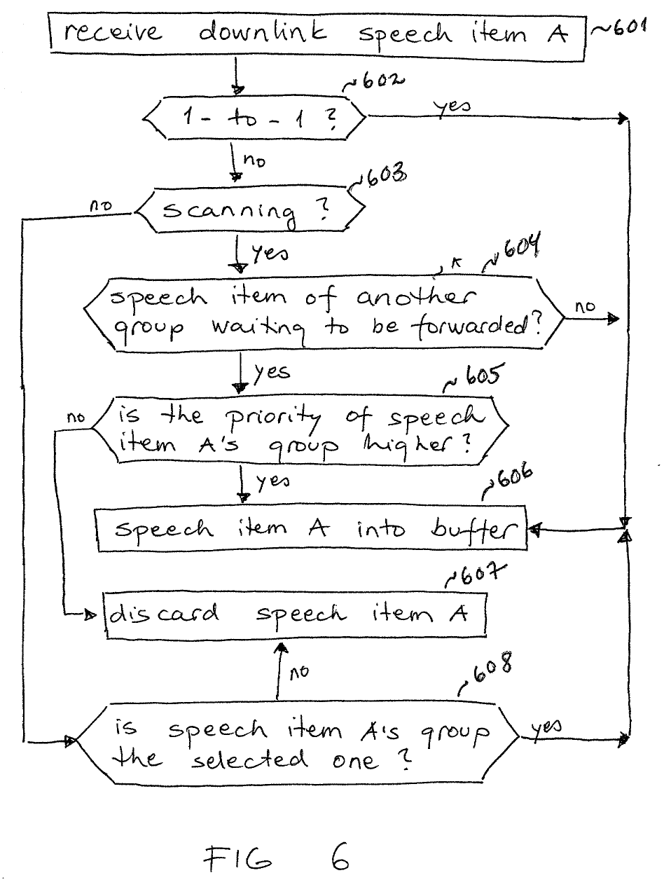

The Megaco connection model according to the invention comprises a user termination UT via which all media streams to and/or from the terminal are transferred. The context 2″, in which the user termination is, bears no significance to the invention. In the exemplary embodiment of the invention there is only one user termination UT for each user who is logged on the system, but the invention is not limited to this particular solution. In some other embodiments of the invention there may be one user termination for the downlink media streams and another user termination for the uplink media streams, for example. The intelligence is transferred from the media gateway controller to the user termination by sending parameters and their values in Megaco messages, as described in detail below with FIGS. 4 and 5. The parameters and their values define the rules (instructions) which are to be applied to the user's media streams. The term ‘parameter’ covers here also an indication identifying the parameter whose value is sent.

The UT contains at least some identification information as a parameter. In the exemplary embodiment of the invention the identification information is the IP address of the user's terminal. In the exemplary embodiment of the invention, the IP address of the user's terminal is the combining factor to the other terminations associated with the user. If the terminal has more than one IP address, all the IP addresses used are preferably parameters in the user's UT. In other embodiments, some other identification information, such as a timeslot for a PCM link, an ATM virtual path identifier or an ATM virtual channel identifier, may be used instead of the IP address or with it.

The UT may also contain uplink insertion parameter/s which define what is added to the media stream originated from the terminal. For example, some identification of the user may be added.

The UT may also contain downlink insertion parameters or a parameter, which define what is added to the media stream transferred to the user. For example, some identification of the media stream originating from a VoIP service may be added.

The UT may also contain downlink filtering parameters or a parameter, which define the way the media gateway can decide which one of the media streams is passed to the user. For example, the filtering parameter(s) may indicate priority settings between the media streams or a fixed selection. With priority settings the user can set those groups in which he is an active member in the order of priority. If there are overlapping speech items (term described in more detail below) of different groups to be forwarded to the user, the UT forwards the one with the highest priority and the rest are not forwarded. With fixed selection the user can set one group to be the one, the speech items of which will be forwarded by the UT and speech items of other groups will not be forwarded (regardless of priorities and whether or not they are overlapping).

The UT may also contain other controlling parameters, such as media stream management timer values, media stream header compressing mode and user's rights concerning the VoIP services.

The parameters and their values are determined on the basis of the user's selections and his fixed settings, such as rights defined in the system for the user. The user may select some parameters during a log on, and/or change/select them during group attachment, by selecting a group, by giving priority settings etc.

When the UT is created and parameters are passed to the media gateway, the media gateway may independently, i.e. without requesting instructions from the media gateway controller, pass only one media stream through in the downlink according to the parameters of the UT, insert additional information to the media stream in the uplink and/or downlink according to the parameters, and/or generate inband information in the downlink, for example. The inband information may be a simple flag, which is interpreted by the terminal, or it may be a real sample of media stream, such as a voice beep, for example. The media gateway may also perform other actions defined by the parameters of the UT.

The user termination is preferably created during the user logging on the system, especially if the user session or a call is initiated by using RTP, which is the case in the PMRoC described below. However, it is possible that the user termination is created only in response to a first call made to or from the user terminal. After being created, the user termination is preferably maintained as long as the user stays logged on the system. However, the user termination may be maintained only as long as the user is involved in a call or is an active member of a group.

The UT according to the invention is preferably defined by using a set of Megaco protocol packages, at least as long as it is not included in the base protocol.

The dashed lines in FIG. 1 represent the flow of media streams and the unbroken lines represent the Megaco connection model between terminations inside a context. In the example illustrated in FIG. 1, if terminations T2 and T4 both receive at the same time a speech item to be delivered to the user equipment UE, the UT filters according to its parameter settings the speech items and forwards either only one of the speech items or none of the speech items to the UT. If the speech items are successive (i.e. not parallel), the UT may forward both of them, only one of them or none of them depending on the parameter settings in the UT.

The present invention is applicable to any digital communications systems which utilize the Megaco protocol. The invention is especially preferably applicable to communications systems disclosed in U.S. patent application Ser. No. 09/835,867, the system being called PMROC, i.e. PMR-over-cellular, where Megaco is used by control plane elements to control RTP routing in user plane elements in systems. The system is also called PoC, i.e. Push-to-talk over Cellular. In the following, the preferred embodiment of the invention will be described by means of the above-mentioned system without limiting the invention to this particular system. The IP voice communication method used in the exemplary embodiment of the invention is the Voice over IP (VoIP), but the invention is not limited to this particular method. The features disclosed in U.S. patent application Ser. No. 09/835,867 and needed to understand the implementation of the present invention are discussed briefly below with FIGS. 2 and 3. The specifications of different communication systems evolve rapidly. This evolution may require extra changes to the invention. Therefore, all terms and expressions should be interpreted as widely as possible and they are intended to describe and not to limit the invention.

PMROC

Professional mobile radio or private mobile radio (PMR) systems are dedicated radio systems developed primarily for professional and governmental users, such as the police, military forces, oil plants, etc. PMR services have been offered via dedicated PMR networks built with dedicated PMR technologies. This market is divided between several technologies—analog, digital, conventional and trunked—none of which has a dominating role. TETRA (Terrestrial Trunked Radio) is a standard defined by ETSI (European Telecommunications Standards Institute) for digital PMR systems.

One special feature offered by the PMR systems is group communication. The term “group”, as used herein, refers to any logical group of three or more users intended to participate in the same group communication, e.g. call. The groups are created logically, i.e. special group communication information maintained on the network side associates specific user with a particular group communication group.

Voice traffic in a group, as seen by the users, consists of speech items (i.e. talkspurts) of more or less continuous speech coming from a specific user to one or more recipients. In the following speech items are used to illustrate items of all possible media streams.

FIG. 2 illustrates the basic architecture of the exemplary embodiment of the invention which is based on the PMR. In the illustrated embodiment, a mobile radio access network (RAN) which provides the IP packet data service is based on a GPRS architecture utilizing a 2G radio access technology, such as a GSM base station system BSS with base stations BTS and base station controllers BSC. The GSM radio access may be conventional or based on the GSM EDGE technique. In the latter case, radio access may be referred to as GERAN which is an all-IP GSM radio access network. Alternatively, a 3G radio access network UTRAN (such as UMTS) may be used. An all-IP core network can be used both in GERAN and UTRAN. The architecture of the mobile network is not essential to the invention, but the GPRS infrastructure and operation will be briefly discussed in order to make it easier to comprehend the PMROC. The GPRS infrastructure comprises support nodes, such as a GPRS gateway support node (GGSN) and a GPRS serving support node (SGSN). The main functions of the SGSN are to detect new GPRS mobile stations in its service area, handle the process of registering new user equipments UE (also called mobile stations MS) along with the GPRS registers, send/receive data packets to/from the UE, and keep a record of the location of the UEs inside of its service area. The subscription information is stored in a GPRS register (HSS, Home Subscriber Server). The main functions of the GGSN nodes involve interaction with external data networks. The GGSN may also be connected directly to a private corporate network or a host. The GGSN includes PDP addresses and routing information, i.e. SGSN addresses for active GPRS subscribers. The GGSN updates the location directory using routing information supplied by the SGSNs. The GGSN uses the routing information for tunneling the protocol data units PDU from external networks to the current location of the UE, i.e. to the serving SGSN, in accordance with the GPRS tunneling protocol (GTP). Tunneling means that the data packet is encapsulated into another data packet during transfer from one end of the tunnel to another. The GGSN also decapsulates data packets received from UEs and forwards them to the appropriate data network. In order to send and receive GPRS data, the UE activates the packet data address that it wants to use, by requesting a PDP activation procedure. This operation makes the UE known in the corresponding GGSN, and interworking with external data networks can commence. More particularly, one or more PDP contexts are created and stored in the UE and the GGSN and the SGSN. The PDP context defines different data transmission parameters, such as PDP type (e.g. X.25 or IP), PDP address (e.g. IP address) and quality of service QoS.

In FIG. 2, a PMR-over-cellular (PMROC) layer is provided on top of the mobile network in order to provide group communication services to the user equipments UE through the mobile network. Conceptually, the PMROC layer comprises the media gateway MG (also called a PMROC bridge) and a PMROC call processing server (CPS) comprising the media gateway controller MGC. The CPS comprises also call control and signaling gateway functionalities. The MG and the MGC (CPS) are connected to the GGSN, typically over an IP network. The media gateway MG and the media gateway controller MGC run PMR applications which communicate with the PMR application(s) in the user equipment UE over the IP connections provided by the IP mobile RAN. This communication includes both signaling packets and group communication packets.

The CPS 11 is responsible for control-plane management of the PMR communications. Its important role may require various functionalities which can be implemented in the following modules: “PMR server”—the application that handles the sessions for group memberships which are signaled with an appropriate session control protocol, such as SIP, established for the PMRoC communications, and manages the users profiles (call rights, group active membership, scanning settings, etc.); SIP Proxy/Location Server—providing user location and routing functionalities of SIP signaling; SIP Registrar—for user registration/authentication; and Media Gateway Controller—controlling the network entities involved in the IP layer data distribution according to the group & user specific information (membership, rights, scanning settings, etc.).

However, since the PMR management requirements can be divided into group and user specific ones, two kinds of media gateway controllers MGC, i.e. CPS servers, are defined in one embodiment of the invention, as illustrated in FIG. 3. The SIP sessions for group communications are handled by a Group Control Plane Function (G-CPF) 23 (e.g. in a server). When a user attaches to a group, the G-CPF 23 takes care of the relative SIP invitation transaction and performs the proper mapping settings between the user's recipient and the network entities responsible for the relative traffic distribution. The User—Control Plane Function (U-CPF) 22 (e.g. a control plane proxy server) is basically the control plane interface between the IP network and the user. By this network entity the users log on to the system and negotiate their operational settings (scanning settings, etc.), which define parameter settings to the corresponding UT. The U-CPF initiates the creation of the UT and modifies the UT, if needed. It should be appreciated that this is just a logical separation, and both kinds of MGC can be situated in the same computer. Separating G-CPF and U-CPF enables users to join PMROC groups handled by G-CPF in different Intranets or in mobile networks of different operators and IP domain. Division also brings scalability by allowing in practice infinite number of groups or users in the system.

Referring again to FIG. 2, the media gateway MG is responsible for the real-time distribution of VoIP packets to the users' terminals according to their group memberships, their scanning settings and eventual preemption or emergency cases. Each media gateway forwards traffic only between valid connections programmed by the MGC. The media gateway MG may perform one or more of the following functionalities:

Input checking: to identify and authenticate the traffic source (optionally the mnemonics in the leader RTP packet, which will be discussed below, have to be processed here). Input checking may also include actions to perform and support security procedures.

Input filtering: to manage that only one talker talks in a group at a time (i.e. grants a speech item), and optionally to give priority to higher priority voice items.

Multiplication: after the filtering process, the media gateway MG has to check the active members of the group to which the traffic is destined and generate from the incoming packet a “downlink” packet for each active member.

Scanning filtering: to select from the multiple incoming traffic streams destined to the same user the one which has to be forwarded to his recipient according to the user's scanning settings.

Again, since input filtering and multiplication are group specific processes, while input checking and scanning filtering are user specific, the following two kinds of media gateways, i.e. application bridges, have been defined in one embodiment of the invention, as illustrated in FIG. 3.

Firstly, a Group—User Plane Function G-UPF 21 (e.g. in a server) is a network entity to which group members' audio packets are sent (through their U-UPF) and where the input filtering and multiplication processes are performed. To each new group the G-CPF 23 assigns a single G-UPF 21 according to load balancing criteria which distributes the traffic as evenly as possible between the G-UPFs.

The User—User Plane Function U-UPF 20 (e.g. in a server), and more precisely the user terminations of the invention, performs the input checking and scanning processes for the individual subscribers which have been assigned to it by the U-CPF 22. For security purposes the U-UPF 20 may have security associations for each mobile terminal it handles. The U-UPF 20 hides the network complexity from the mobile terminals, so the user has just to send all his user plane traffic to this unit where the user plane traffic is directed via user's user termination and after the user termination the unit forwards the user plane traffic according to the mapping settings of the proper U-CPF 22. In this way there is no need to establish secure channels between each user and all the IP network entities which have just to trust the U-UPF 20 from which they receive packets.

As for the Control Plane elements, this logical splitting does not necessarily require a physical separation between the G-UPF and the U-UPF implementations, and thus they may be located in the same computer.

The U-CPF 22 and the G-CPF 23, which are responsible for managing the sessions of the users and the groups, respectively, require specific control plane signaling. ETSI 3GPP (European Telecommunications Standards Institute, 3rd Generation Partnership Project) specifications include IP based voice communications in a so called all-IP network. Such an all-IP network enables also voice communication in IP network (voice over IP, VOIP). For VoIP, call control signaling is specified, such as the SIP, which is defined in the RFC2543. Therefore, in the exemplary embodiment, the SIP has been chosen to support and manage the PMRoC call sessions. However, some other IP session protocol may be used instead. Further, the Megaco is used by the G-CPFs 23 and the U-CPF 22 to control the G-UPFs 21 and U-UPFs 20 involved in traffic distribution of the IP layer. Still further, the RTP (Real Time transport Protocol) protocol has been chosen to handle the transfer, and QoS mechanisms are needed to handle the voice packet (VoIP) delivery.

The SIP protocol defines signaling messages for call control, user location and registration, and these have been used in the preferred embodiment of the PMROC solution to handle the specific PMR communications and the relative participating users (establishment, joining and tear down of a call session, user's log on to PMROC services, user's profile negotiation, etc).

For each PMROC communication, a SIP session is established and managed by the MGC, i.e. the CPS handling it (G-CPF 23 and U-CPF 22 for group and one-to-one communications respectively). When a user wants to become an active member of a group, he has to join the corresponding session. For individual calls, the PMROC U-CPFs maintain one session per user for all individual calls. This individual call session is always on when the user is logged on to PMRoC services and the user has selected individual call service to be in use.

All the user's outgoing and incoming traffic has to go through the U-UPF 20 that has been assigned to the user by his U-CPF 22, and more precisely via the user termination of the present invention. In particular, in the uplink the user's traffic is checked by his U-UPF 20 and forwarded to the G-UPF 21 handling the group to which the traffic is destined or, in case of one-to-one communication, to the U-UPF 20 handling the called party. Signaling packets embedded to RTP messages are also transferred via the user termination.

In the downlink, the traffic is then distributed to the destination users' media gateways U-UPFs 20 (by packet multiplication in the G-UPF 21 in case of group communication) where the users' scanning and/or filtering processes are performed by the user terminations according to the present invention and from where the traffic is delivered to the recipients.

Each user termination in the U-UPF may contain in addition to the user equipment's IP address also user's URL (uniform resource locator), user's default mnemonic for one-to-one calls, flags indicating the user's right for URL presentation restriction, group selection information, group-SSRC and/or group-mnemonic for each group the user is attached to. In PMRoC the URL is used also as an identifier in charging records, i.e. in CDRs. A mnemonic can be compared to a nickname and referred to as an identity shown to another party (other parties) of the call. If the URL presentation restriction is on, the UT takes care that the user's URL is not shown to another party (other parties), but the mnemonic is. The group-SSRC is used as a user's identifier between the U-UPF and G-UPF.

This PMRoC solution is access independent, which means that it can run on top of GSM, WCDMA, WLAN or equivalent technologies as long as these are able to support the always-on VoIP bearers. The IP layer's audio distribution uses standard VoIP mechanisms (such as the RTP), while specific Internet protocols or interfaces will be used to connect supplementary network entities, such as Subscriber and Group Management Function (SGMF) 25, a Domain Name Server (DNS) 24, WWW/WAP (World Wide Web/Wireless Application Protocol) and security management servers. Each network entity is obviously associated with at least one IP address by which the IP packets are transferred and routed, but the role of the network elements have also to be defined from the SIP's point of view. Each UE is a SIP User Agent (UA), and thus each one has a SIP address (URL) which normally is “username@hostname” where the hostname can be, but not necessarily is associated with the U-CPF 22 in which the UE has to register. This U-CPF 22 should act as a Registrar, Location and Proxy SIP server in order to allow the reachability of the MSs under its control and to support the SIP signaling routing. The G-UPFs 21 and U-UPFs 20, which are exclusively involved in the audio data distribution, do not have a role in the actual SIP mechanisms and the core network is simply seen as a single IP network link. However, the addressing details are not essential for the invention and thus need not be discussed in more detail here.

Additionally, an SGMF 25 is preferably provided in PMRoC system for management and information query/updating purposes. Via SGMF 25, operator or a normal user having management rights can create, delete and modify users and groups in PMROC system. Also access rights related to users and groups can be created and modified. The information itself can be contained in a database, such as Structured Query Language (SQL) database or in a directory, such as Lightweight Directory Access Protocol (LDAP, defined in RFC2251) directory. These data repositories can be stand-alone or co-located with SGMF 25. This database or directory is the main data repository in PMRoC system. Normal users having management rights can access SGMF using a WWWIWAP interface. An important function of SGMF 25 is also processing requests coming from U-CPF 22 and G-CPF 23 and making database or directory fetches and updates according to the requests. However, it is irrelevant for the present invention how the group creation and management is performed and how (and where) the fixed settings of a user and other settings affecting to the parameters in the user termination for the user are maintained and accessed in the system.

SOAP or a similar protocol can be used in the interface between U-CPF 22 and SGMF 25 as well as in the interface between G-CPF 23 and SGMF 25.

The user equipment UE, or mobile station, has a PMROC application on a user layer on top of the standard protocol stack used in the specific mobile communications system. The SIP and RTP protocols employ the underlying TCP, UDP and IP protocols which further employ the physical layer resources, such as the radio resources. Additionally, a WAP stack may be employed to access the WAP pages on the group management server.

Creation of User Termination in PMROC

Before the user can start to use PMROC services he has to register himself with his media gateway controller, i.e. U-CPF in FIG. 3, whose address has to be determined by DNS services. This registration is also called logging on the system. In the exemplary embodiment of the invention the user first makes a DNS query. The DNS returns the IP address of the U-CPF. However, it is irrelevant for the invention how the IP address of the U-CPF is determined.

Referring to FIG. 4, once the UE knows the IP address of the U-CPF it sends a SIP registration message 4-1 to the U-CPF. The SIP registration message contains among other things user's SIP URL, port number in terminal for One-to One calls and scanning settings for One-to-One calls. It may contain also the mnemonic that the user wants to use for One-to-One calls. The foregoing parameters are parameters that may be sent to the UT. In response to message 4-1, the U-CPF sends message 4-2, which contains an authorization challenge. The UE responds by sending message 4-1′, which is the previously sent SIP registration message 4-1, with authentication response.

When the U-CPF receives the registration message with authentication response from the user's UE, it authenticates the user. If the user passes the authentication (as is the case in the example of FIG. 4), the U-CPF has to select and assign to the user a U-UPF 20 where his user termination has to be created and where the user has to send his user plane traffic. When the U-UPF has been selected, the user and the user termination is added to the selected U-UPF by sending to it message 4-3 comprising the Add command of the Megaco protocol.

The message may be as follows (parameter values are purely imaginary in all messages described here):

Message {

Version = x
IP6Address {

address = U-UPF's address
portNumber = 2944}

Transaction = 10002

contextID = $ {

Add {

TerminationID = $
MediaDescriptor {

LocalControlDescriptor {

reserveValue = NOT USED
reserveGroup = NOT USED
User/TermIP = 1.1.0.1
User/RTPhead = 0x1
User/HeartbeatInt = 5
User/UserURL = my
User/UserMne = mee
User/RiVR = yes}}}}}}

In this example (and in the following examples) it is assumed that packages are used and the media gateway recognizes that this add command relates to the user termination on the basis of the parameters. However, in some other embodiment it is possible that the add command contains indication or indications, such as a flag, on the basis of which the media gateway recognizes that the message relates to the user termination.

The user-termination-specific parameters of this message, defined in the package(s), are indicated by the word ‘User’ before the parameter. In this exemplary message the user-termination-specific parameters are an IP address of the user's terminal (TermIP), an RTP header mode (RTPhead), a heartbeat interval (HeartbeatInt), the user's URL (UserURL), the user's mnemonic for one-to-one calls (UserMne) and the user's rights to block URL visibility in one-to-one calls (RiVR). When creating the user termination, the media gateway controller U-CPF also asks for a termination identifier value for the UT (TerminationID) and a context identifier value (Context id) by using standard Megaco wildcard mechanism. The wildcard in Megaco is $. Other parameters in the message (and in the add command) are standard Megaco parameters or based on standard Megaco parameters and thus need not be explained here. The parameter values for user termination specific parameters are based on the user's access rights and other fixed settings and/or parameters in message 4-1.

After receiving message 4-3, the U-UPF creates at point 4-4 the UT and its context. Depending on the user's parameters the UT may contain only the address identifying the user, such as the user's SIP URL or the IP address of the user's terminal. The user's SIP URL is typically used also for charging services. The U-UPF sends an acknowledgement according to the Megaco protocol in message 4-5, the acknowledgement indicating requested values, i.e. values that had wildcard in message 4-3.

The acknowledgement message typically contains the requested information and message 4-5 may be as follows:

Message {

Version = x
IP6Address {

address = U-CPF's address
portNumber = 2944}

Reply = 10002{

contextID = 10002 {
TerminationID = A4444 }}}

After receiving message 4-5, the U-CPF sends message 4-6, which preferably contains the address of the U-UPF and an indication indicating that the user is now logged to the system.

The user has to send all his user plane traffic to the U-UPF assigned to him by his U-CPF, and in case the traffic is destined to a group then the specific port number associated by the U-UPF with the group is used for traffic identification purposes. Thus, all the user plane traffic, i.e. all media streams, passes the user termination in the U-UPF.

Modification of the UT in PMROC

Parameters of UT may be added or removed or their values may be changed. Parameter settings of the UT will be changed when someone is calling the user, the user logs on although he was not logged off or the user changes his scanning settings or group selections, for example.

FIG. 5 shows one example of how the user termination is modified. Referring to FIG. 5, the user sends a new specific registration message 5-1 to his U-CPF. Afterwards the U-CPF performs the consequent operations required, such as a SIP session invitation in the G-UPFs, which are not shown in FIG. 5. The U-CPF also modifies the settings of the U-UPF, i.e. modifies the user termination, by sending Megaco message 5-2 to the U-UPF. The Megaco message comprises the Modify command. The modify command may be as follows when someone is calling the user or the user logs on although he was not logged off:

Message {

Version = x
IP6Address {

address = U-UPF's address
portNumber = 2944}

Transaction = 10003 {

contextID = 2001 {

Modify {

TerminationID = A4444
MediaDescriptor {

LocalControlDescriptor {

reserveValue = NOT USED
reserveGroup = NOT USED

User/TermIP = 1.1.0.1
User/RTPhead = 0x1
User/HeartbeatInt = 5
User/UserURL = my
User/UserMne = mee
User/RiVR = yes
User/GrSel = 08}}}}}}

In this message one new user termination specific parameter (compared to message 4-3), defined in the package(s), is the identifier for the selected group (GrSel). It may be a context identifier of the context holding terminations for the selected group. If the call is not a group call, or no group is selected during log on, the parameter may be left out from the message.

If the user wants to join a group, message 5-2 can be as follows:

Message {

Version = x
IP6Address {

address = U-UPF's address
portNumber = 2944}

Transaction = 10003 {

contextID = 2001 {

Modify {

TerminationID = A4444
MediaDescriptor {

LocalControlDescriptor {

reserveValue = NOT USED
reserveGroup = NOT USED
GroupAttU/AttGr = 08
GroupAttU/GrURL = groupy
GroupAttU/UserSSRC = 0
GroupAttU/UserMne = fellow
GroupAttU/VRAc = no
GroupAttU/GrType = 0x1}}}}}}

In this message a group attachment package for users is used and the parameters are indicated by the ‘GroupAttU’. On the basis of the indication the media gateway knows that these parameters affect the user termination. The parameters are an identifier of the attached group (AttGr), which may be a context identifier of the context which holds terminations for the group, an URL of the group (GrURL), the user's SSRC in the group (UserSSRC), the user's mnemonic in the group (UserMne), an indication whether or not the URL visibility is active in the group (VRAc) and a group type (GrType). The group type may be a normal group (0×1) or an ad hoc group, for example.

If the user wants to select or deselect a group, message 5-2 can be as follows:

Message {

Version = x
IP6Address {

address = U-UPF's address
portNumber = 2944}

Transaction = 10003 {

contextID = 2001 {
Modify {

TerminationID = A4444
MediaDescriptor {
LocalControlDescriptor {

reserveValue = NOT USED
reserveGroup = NOT USED
User/GrSel = 06}}}}}}

The U-UPF modifies, at point 5-3, the user termination according to the message 5-2 and creates new prior art terminations for the group, if needed. Then the U-UPF sends an acknowledgement in message 5-4 to the U-CPF. The acknowledgment message may be similar to above message 4-5 in FIG. 4 when the modification was successful. Finally the U-CPF provides the UE with the resulting information in message 5-5.

As can be seen, the parameters in the Modify command depends on what the user or the operator wants to change and thus the parameters in the UT are not limited to the ones described herein.

Filtering

The ability to belong to many groups creates a situation where there can be simultaneous media streams targeted to the user. However, only one of the media streams is played to the user. In order not to send media streams in vain to the user's terminal, filtering function is implemented in the network. More precisely, the filtering function may be implemented by the user termination according to the invention.

In the basic mode, the mobile user selects one group for communication. He will then hear all traffic in that group (unless he is engaged in an individual call) and can also himself talk in the group. The user can easily switch to another group.

The user can also operate in multiple groups virtually at the same time, by using a method called scanning. The user selects multiple groups and assigns these with priorities. He then hears traffic from one group at the time, but traffic from a more important group will interrupt other traffic. One of the groups remains the selected group, and any speech transmission by the user is made to the selected group. The user can switch scanning on and off. The list of scanned groups with priorities can be edited by the user. Group selection and other settings can also be performed remotely.

In order to ensure conversation continuity (i.e. to ensure that a listener receives a coherent series of transmissions), the U.S. patent application Ser. No. 09/835,867 discloses that a specific timer (or timers) is provided in the media gateway. The timer is set in the media gateway to a predetermined “pause period” corresponding maximum period of time between two consecutive media stream packets in the selected media stream, when the media stream is selected. When the timer is implemented with the user termination it is also possible to ensure that a speech coming from a specific user is not interrupted even when an overriding speech item arrives, unless the parameters in the user termination instruct on the contrary. By the parameters of the user termination there is no need to request the length of the “pause period” every time a new media stream is selected. It is even possible to have different “pause periods” in the UT for different media streams.

FIG. 6 illustrates a filtering process performed by a user termination in an embodiment in which speech coming from a specific user may be interrupted when an overriding speech item arrives. In the example of FIG. 6 it is assumed that one-to-one calls are prioritised and there can be at most one one-to-one call going on. It is further more assumed, for the sake of clarity, that the user termination has a sending buffer, the size of which is one speech item. (In other words it is assumed that speech items from one speaker are forwarded so that the buffer is empty when the next speech item arrives.) It is also assumed that, in the case of group speech, there are no overlapping speech items of the same group. Furthermore, it is assumed that if the priorities of overlapping group calls are the same, the earlier speech item is the one which is forwarded.

Referring to FIG. 6 the user termination receives, in step 601, a speech item A from speaker A directed to the user the user termination relates to. The user termination checks, in step 602, if the speaker A is involved in a one-to-one call with the user. If not, the speech item A belongs to a group call and the user termination checks, in step 603, whether the scanning is on or off. If the scanning is on, the user termination checks, in step 604, whether there is already a speech item in the sending buffer waiting to be forwarded. If there is, the UT checks, in step 605, whether the priority of the group the speech item A belongs to is higher than the priority of the group the speech item in the buffer belongs to. If the group of speech item A has higher priority, the speech item A is placed in the buffer in step 606 and the one which was there waiting for to be forwarded, is discarded. If the group of speech item A has not a higher priority (step 605), the speech item A is discarded in step 607 and the one in the buffer remains there.

If the scanning is on (step 603) and the sending buffer is empty (step 604), the speech item A is placed into the buffer in step 606.

If the scaning is off (step 603), the user termination checks, in step 608, whether the group the speech item A belongs to is the selected group. If the speech item A belongs to the selected group, the speech item A is placed in the buffer in step 606. If the speech item A does not belong to the selected group, the speech item A is discarded in step 607.

If the speech item A is an item of a one-to-one call (step 602), the speech item A is placed in the buffer in step 606. If there already was a speech item of a group in the buffer waiting to be forwarded, it is discarded.

In an embodiment in which speech coming from a specific user is not interrupted when an overriding speech item arrives, it is checked in response to receiving the speech item A (step 601) whether the specific speaker has an ongoing speech. If not, the buffer may still have a speech item which is starting speech, and the steps shown in FIG. 6 are performed. If there is an ongoing speech of a specific speaker, the speech item A is preferably discarded and, when the ongoing speech ends, the user termination may or may not interrupt the media stream of the call in which the specific speaker was a member, depending on the priorities of the ongoing call and the speech item A's call and parameter settings in the UT. Different timers and their checking, such as ensuring that a speech is not interrupted, need not be discussed here.

Adding Inband Information

There are situations where it is convenient for the user to receive some information from the system. One example of such a situation is, that the user requests a service to which he has no access rights. Another example is a call set up delay experienced by the caller which may be shortened by the user equipment giving an audible indication to the user to start speaking. There are several points at which the permission to speak can be given. One suitable point is after the uplink radio bearer has been allocated and after the first RTP message (so called Leader packet, non-voice) has been sent to the RAN. Notice that the downlink status is not known at this point. In case of call failure because of a missing B party or missing radio bearers in the downlink direction or a failure of a call authorization check, the user gets an indication of a call failure. The indication to speak could be alternatively given after the media gateway MG gives an acknowledgement of, for example, having processed the first RTP packet or even of the B party having acknowledged the header packet.

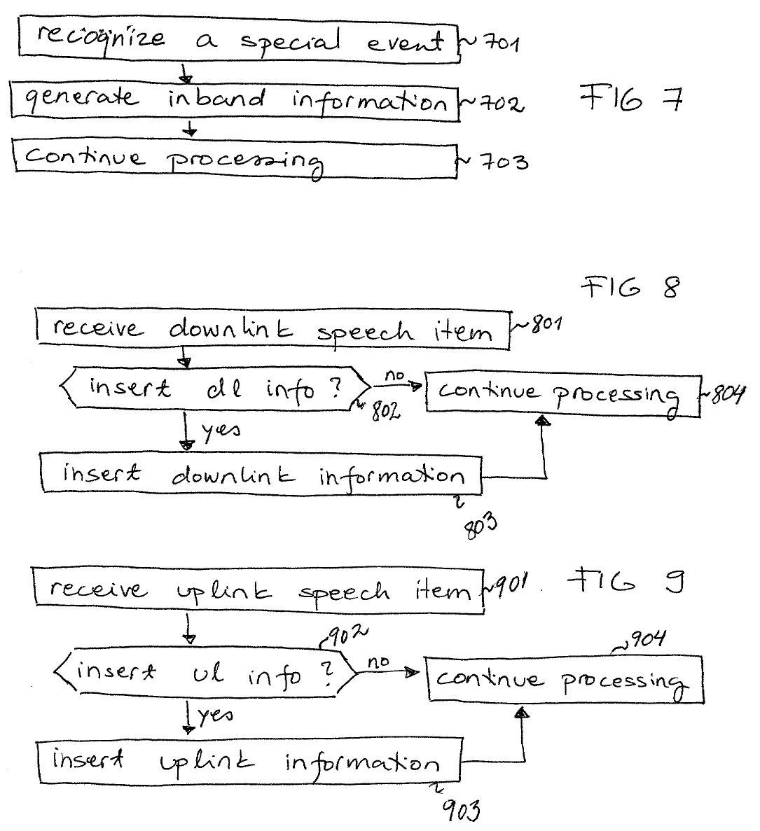

FIG. 7 illustrates the functionality of the user termination when inband information is sent to the user. The user termination recognizes, in step 701, a special event, examples of which are disclosed above, and generates, in step 702, inband information relating to the special event according to the parameters and their values in the user termination. The inband information is then sent, in step 703, to the user.

Adding Downlink Information

By means of the user termination it is possible to add information to media streams or to a media stream targeted at the user without requesting additional information from the media gateway controller. One example of such information is some identification of the service the media streams originates from. This information may be played or showed to the user when the speech item is received in the user equipment.

FIG. 8 illustrates the functionality of the user termination when downlink information may be added to speech items. When a speech item is received (step 801) in the user termination, the user termination checks, in step 802, whether downlink information (dI info) should be added to the speech item. If the parameters in the UT indicate that downlink information should be added, downlink information is added, in step 803, to the speech item, after which the processing of the speech item is continued in step 804 (e.g. the speech item is set to the buffer to wait to be forwarded). If no downlink information is added (step 802), the processing is continued in step 804.

With the parameters in the user termination, different kinds of rules to be applied to different kinds of downlink media streams may be defined. For example, with different parameters and their different values it is easy to define that in one-to-one calls downlink information on the speaker is added to the very first speech item, in group A media streams downlink information on the speaker is added to each speech item, in group B media streams downlink information on the speaker is added to the first speech item of a new speaker, i.e. after the speaking turn has changed and no downlink information is added to group C media streams.

When the information is added in the user termination, it is not transferred unnecessarily in the whole network. This also gives the possibility to customize services, information may be added only to those users who want it by giving different parameter values during service provisioning.

The adding of downlink information is preferably performed after the filtering process.

Adding Uplink Information

By means of the user termination it is also possible that information is added to media streams or to a media stream originated from the user without requesting additional information from the media gateway controller. One example of such information is whether user's mnemonic and/or URL are added to the media stream.

FIG. 9 illustrates the functionality of the user termination when uplink information may be added to speech items. When a speech item is received (step 901) in the user termination, the user termination checks, in step 902, whether uplink information (ul info) should be added to the speech item. If the parameters indicate that uplink information should be added, uplink information is added, in step 903, to the speech item, after which the processing of the speech item is continued in step 904 (e.g. the speech item is forwarded). If no uplink information is added (step 902), the processing is continued in step 904.

With the parameters in the user termination, different kinds of rules to be applied to different kinds of uplink media streams may be defined. For example, with different parameters and their different values it is easy to define that both the URL and mnemonic are added to speech items of group A and only the URL is added to speech items of group B.

The signaling messages and steps in FIGS. 4 to 9 are not in an absolute chronological order. Some of the steps described above may also take place simultaneously or in another order and signaling messages can be transmitted in a different order. Other signaling messages can also be transmitted, and/or other functions can also be performed between the messages and/or other steps not shown may take place between the steps mentioned above. Correspondingly, some steps may be skipped, and some of the messages shown may also be left out. The signaling messages are only examples and they may comprise several independent messages for transferring the same information. In addition, the messages may also comprise other information or less information than what is disclosed in the examples.

The above embodiments of the invention are only examples, and in order to have new embodiments according to the invention the features described in the embodiments can be combined in a different manner than what is described above.

Although the invention has been described above with the PMRoC system it is obvious for one skilled in the art that the invention can be implemented with every system utilizing the Megaco protocol.

It will be obvious to a person skilled in the art that, as the technology advances, the inventive concept can be implemented in various ways. The invention and its embodiments are not limited to the examples described above but may vary within the scope of the claims.

What is claimed is:

1. A method of providing a mechanism to transfer user-related information from a media gateway controller to a media gateway transferring media streams to and from a user in a telecommunications system, the method comprising:
creating in the media gateway a user termination for the user's user-related information, the user termination being non-call-specific and associated with the user; and
directing the media streams via the user termination.

2. The method of claim 1, further comprising:
receiving in the media gateway at least one parameter with its value as the user's user-related information; and
storing the parameter and its value to the user termination; and
applying the stored parameter according to its value to the media streams.

3. The method of claim 2, wherein the parameter relates to filtering media streams targeted at the user.

4. The method of claim 2, wherein the parameter relates to adding inband information.

5. The method of claim 2, wherein the parameter relates to adding downlink information.

6. The method of claim 2, wherein the parameter relates to adding uplink information.

7. The method of claim 1, wherein the user termination is created during the user logging to the system.

8. The method of claim 1, wherein the user termination is created during the user logging to the system and maintained as long as the user stays logged on to the system.

9. The method of claim 1, wherein the user termination is defined by packages of the Mecago-protocol.

10. The method of claim 1, further comprising
modifying the user termination by adding, subtracting or modifying information in the user termination.

11. A method of applying at least one instruction to media streams transferred to a user in a media gateway via which the media streams are transferred in a telecommunications system further comprising a media gateway controller controlling the media gateway, the method comprising:
creating in the media gateway a user termination for the user's user-related information, the user termination being non-call-specific and associated with the user;
receiving in the media gateway at least one parameter with its value as the user's user-related information;
storing the parameter and its value to the user termination;
directing the media streams to the user via the user termination; and
applying the stored parameter according to its value to the media streams directed to the user.

12. A method of applying at least one instruction to media streams transferred from a user in a media gateway via which the media streams are transferred in a telecommunications system further comprising a media gateway controller controlling the media gateway, the method comprising:
creating in the media gateway a user termination for the user's user-related information, the user termination being non-call-specific and associated with the user;
receiving in the media gateway at least one parameter with its value as the user's user-related information;
storing the parameter and its value to the user termination;
directing the media streams from the user via the user termination; and
applying the stored parameter according to its value to the media streams originated from the user.

13. A method of filtering media streams targeted at a user in a telecommunications system comprising a media gateway transferring the media streams to the user and a media gateway controller controlling the media gateway, the method comprising:
receiving in the media gateway a message from the media gateway controller, the message indicating that a user termination is to be created for the user's filtering information, the user termination being non-call-specific and associated with the user;
creating in response to the message the user termination;
receiving in the media gateway at least one parameter with its value as the user's filtering information;
storing the parameter with its value to the user termination;
directing the media streams to the user via the user termination; and
filtering the media streams according to the parameter and its value.

14. A network node in a telecommunications system comprising at least a media gateway functionality transferring media streams to and from a user, the network node comprising at least media gateway controller functionality of the Megaco protocol, the media gateway controller functionality controlling the media gateway functionality and being configured to send an add command to the media gateway, the add command causing a user termination to be created in the media gateway functionality, the user termination being non-call-specific and associated with the user, and to send at least one parameter with its value to the user termination, the parameter being one of the parameters relating to the user.

15. The network node of claim 14, wherein the media gateway controller functionality is further configured to send a modify command to the media gateway functionality in response to a parameter value change, the modify command causing the media gateway functionality to amend the content of the user termination.

16. A network node in a telecommunication system comprising at least a media gateway controller functionality of the Megaco protocol, the network node comprising a media gateway functionality arranged to transfer media streams to and from a user, the media gateway functionality being configured to be controlled by the media gateway controller functionality, to create a user termination in response to an add command received from the media gateway control functionality, the add command indicating that the user termination should be added, the user termination being non-call-specific and associated with the user, and to direct all the media streams via the user termination.

17. A network node in a telecommunication system comprising at least a media gateway controller functionality of the Megaco protocol, the network node comprising a media gateway functionality arranged to transfer media streams to a user, the media gateway functionality being configured to be controlled by the media gateway controller functionality, to create a user termination in response to an add command received from the media gateway control functionality, the add command indicating that the user termination should be added, the user termination being non-call-specific and associated with the user, to add to the user termination at least one filtering parameter with its value sent by the media gateway controller functionality, to direct all the media streams via the user termination, and to filter the media streams according to the filtering parameter and its value.

18. The network node of claim 17, being further configured to add to the user termination at least one parameter with its value, the parameter relating to adding information to the media streams, and to add information to the media streams according to the parameter and its value.

19. The network node of claim 17, being further configured to add to the user termination at least one parameter with its value, the parameter relating to generating inband information, and to generate inband information according to the parameter and its value.

20. The network node of claim 17, being further configured to add to the user termination at least one adding parameter with its value, the adding parameter relating to adding information to the media streams, and at least one generating parameter with its value, the generating parameter relating to generating inband information, and to add information to the media streams and generate inband information according to the parameters and their values.

21. A network node in a telecommunication system comprising at least a media gateway controller functionality of the Megaco protocol, the network node comprising a media gateway functionality arranged to transfer media streams to and from a user, the media gateway functionality being configured to be controlled by the media gateway controller functionality, to create a user termination in response to an add command indicating that a user termination should be added, the user termination being non-call-specific and associated with the user, to add to the user termination at least one parameter with its value sent by the media gateway controller functionality, the parameter relating to adding information, to direct all the media streams via the user termination, and to add information to the media streams according to the parameter and its value.

22. A network node in a telecommunication system comprising at least a media gateway controller functionality of the Megaco protocol, the network node comprising a media gateway functionality arranged to transfer media streams to and from a user, the media gateway functionality being configured to be controlled by the media gateway controller functionality, to create a user termination in response to an add command received from the media gateway control functionality, the add command indicating that the user termination should be added, the user termination being non-call-specific and associated with the user, to add to the user termination at least one parameter with its value sent by the media gateway controller functionality, the parameter relating to generating inband information, to direct all the media streams via the user termination, and to generate inband information according to the parameter and its value.

23. A telecommunications system comprising
at least one user to whom information is sent in media streams;
at least one media gateway functionality arranged to transfer media streams to and from the user;
a media gateway controller functionality controlling the media gateway, wherein
the media gateway controller is configured to send to the media gateway functionality an add command indicating that a user termination should be added, the user termination being non-call-specific and associated with the user; and
the media gateway is configured to create the user termination in response to the received add command and to direct media streams to and from the user via the user termination.

24. The telecommunications system of claim 23, wherein
the media gateway controller is further configured to send to the user termination at least one filtering parameter; and
the media gateway is further configured to store the filtering parameter to the user termination and to filter media streams targeted to the user according to the parameter.

25. The telecommunications system of claim 23, wherein
the media gateway controller is further configured to send to the user termination at least one parameter relating to adding information; and
the media gateway is further configured to store the parameter to the user termination and to add information to media streams if the parameter indicates so.

26. The telecommunications system of claim 23, wherein
the media gateway controller is further configured to send to the user termination at least one parameter relating to generating inband information; and
the media gateway is further configured to store the parameter to the user termination and to generate inband information if the parameter indicates so.

27. The Megaco protocol used between a media gateway and a media gateway controller controlling the media gateway, wherein the protocol comprises user terminations in the media gateway, each user termination being non-call-specific and associated to a corresponding user and via which user termination media streams targeted at or originated from the user are directed.

28. The Megaco protocol of claim 27, wherein the packages of Megaco protocol are used to define the user termination.
